(19) United States
(12) Patent Application Publication
(10) Pub. No.: US 2026/0173199 A1
(43) Pub. Date: Jun. 18, 2026

(54) METHOD AND APPARATUS FOR HANDLING RELEASE OF CFRA RESOURCE FOR L1 SIGNALING BASED MOBILITY IN WIRELESS COMMUNICATION SYSTEM

(71) Applicant: Samsung Electronics Co., Ltd., Suwon-si, Gyeonggi-do (KR)

(72) Inventor: Anil AGIWAL, Suwon-si (KR)

(21) Appl. No.: 19/122,095

(22) PCT Filed: Nov. 1, 2023
(86) PCT No.: PCT/KR2023/017270

§ 371 Date: Apr. 17, 2025

(30) Foreign Application Priority Data
Nov. 2, 2022 (KR) 10-2022-0144794

(51) Int. Cl. H04W 76/27; H04W 74/0838; H04W 76/18

(52) U.S. Cl. CPC H04W 76/27; H04W 74/0838; H04W 76/18

(57) ABSTRACT

The disclosure relates to a 5G or 6G communication system for supporting a higher data transmission rate. A method performed by a terminal in a wireless communication system is provided. The method includes receiving a configuration message including information on a contention free random access (CFRA) resource, receiving a lower layer triggered mobility (LTM) cell change command to switch to a target cell, initiating a random access procedure for the target cell using the CFRA resource, and upon completion of the random access procedure, maintaining the CFRA resource.

### TECHNICAL FIELD

The disclosure relates to a wireless communication system. More particularly, the disclosure relates to an apparatus, a method and a system for handling release of contention-free random access (CFRA) resource for a layer-1 (L1) signaling based mobility in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

In wireless communication systems, contention-free random access (CFRA) can be supported for L1/L2 based mobility. Such CFRA resources for L1/L2 mobility may be signaled using Radio Resource Control Reconfiguration (RRCReconfiguration) or via L1/L2 cell change commands for each respective candidate target cell. However, once the random access procedure for L1/L2 based mobility has been completed, the subsequent behavior of the UE remains undefined. Specifically, it is unclear whether the UE should release resources or maintain the configuration.

### Solution to Problem

In accordance with an aspect of the disclosure, a method performed by a terminal in a wireless communication system is provided. The method includes receiving a configuration message including information on a contention free random access (CFRA) resource, receiving a lower layer triggered mobility (LTM) cell change command to switch to a target cell, initiating a random access procedure for the target cell using the CFRA resource, and upon completion of the random access procedure, maintaining the CFRA resource.

In accordance with another aspect of the disclosure, a terminal in a wireless communication system is provided. The terminal includes a transceiver and a controller. The controller is configured to receive, via the transceiver, a configuration message including information on a CFRA resource, receive, via the transceiver, an LTM cell change command to switch to a target cell, initiate a random access procedure for the target cell using the CFRA resource, and upon completion of the random access procedure, maintain the CFRA resource.

### Advantageous Effects of Invention

According to an embodiment of the disclosure, CFRA resources may be more efficiently utilized when a terminal performs L1/L2 based mobility in a wireless communication system.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates a signaling procedures for an inter-gNB handover according to an embodiment of the disclosure.

FIG. 2a illustrates a first method in a lower layer based mobility procedure according to an embodiment of the disclosure.

FIG. 2b illustrates a first method in a lower layer based mobility procedure according to an embodiment of the disclosure.

FIG. 3a illustrates a second method in a lower layer based mobility procedure according to an embodiment of the disclosure.

FIG. 3b illustrates a second method in a lower layer based mobility procedure according to an embodiment of the disclosure.

FIG. 4 illustrates a block diagram of a terminal according to an embodiment of the disclosure.

FIG. 5 illustrates a block diagram of a base station according to an embodiment of the disclosure.

Throughout the drawings, like reference numerals will be understood to refer to like parts, components, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5gNB), or gNB.

The “UE” is an entity communicating with a BS and may be referred to as UE, device, mobile station (MS), mobile equipment (ME), or terminal.

In the recent years, several broadband wireless technologies have been developed to meet the growing number of broadband subscribers and to provide more and better ap-plications and services. The second-generation wireless communication system has been developed to provide voice services while ensuring the mobility of users. Third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. So fifth generation wireless communication system (also referred as next generation radio or NR) is being developed to meet the growing demand for high speed data services, support ultra-reliability and low latency applications.

The fifth generation wireless communication system supports not only lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive Multiple-Input Multiple-Output (MIMO), Full Dimensional MIMO (FD-MIMO), array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system would be flexible enough to serve the UEs having quite different capabilities depending on the use case and market segment the UE cater service to the end customer.

Few examples of use cases in the fifth generation wireless communication system wireless system that are expected to address are enhanced Mobile Broadband (eMBB), massive Machine Type Communication (m-MTC), ultra-reliable low latency communication (URLLC) etc. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the Internet of Things (IoT)/Internet of Everything (IoE) envisioning connectivity of billions of devices. The URLL requirements like very low latency, very high reliability and variable mobility so on and so forth address the market segment representing the Industrial automation application, vehicle-to-vehicle/vehicle-to-infrastructure communication foreseen as one of the enablers for autonomous cars.

In the fifth generation wireless communication system operating in higher frequency (mmWave) bands, UE and gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end.

In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array.

The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as transmit (TX) beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of receive (RX) beam patterns of different directions. Each of these receive patterns can be also referred as receive (RX) beam.

The fifth generation wireless communication system, supports standalone mode of operation as well dual connectivity (DC). In DC a multiple Rx/Tx UE may be configured to utilise resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in RRC_CONNECTED is configured to utilise radio resources provided by two distinct schedulers, located in two different nodes connected via a non-ideal backhaul and providing either evolved-universal terrestrial radio access (E-UTRA) (i.e. if the node is an ng-eNB) or NR access (i.e. if the node is a gNB).

In NR for a UE in RRC_CONNECTED not configured with CA/DC there is only one serving cell comprising of the primary cell. For a UE in RRC_CONNECTED configured with carrier aggregation (CA)/ DC the term ‘serving cells’ is used to denote the set of cells comprising of the Special Cell(s) (SpCell(s)) and all secondary cells. In NR the term Master Cell Group (MCG) refers to a group of serving cells associated with the Master Node, comprising of the PCell and optionally one or more SCells. In NR the term Secondary Cell Group (SCG) refers to a group of serving cells associated with the Secondary Node, comprising of the PSCell and optionally one or more SCells. In NR primary cell (PCell) refers to a serving cell in MCG, operating on the primary frequency, in which the UE either performs the initial connection establishment procedure or initiates the connection re-establishment procedure.

In NR for a UE configured with CA, Scell is a cell providing additional radio resources on top of Special Cell. Primary SCG Cell (PSCell) refers to a serving cell in SCG in which the UE performs random access when performing the Reconfiguration with Sync procedure. For Dual Connectivity operation the term SpCell (i.e. Special Cell) refers to the PCell of the MCG or the PSCell of the SCG, otherwise the term Special Cell refers to the PCell.

In the fifth generation wireless communication system, Physical Downlink Control Channel (PDCCH) is used to schedule DL transmissions on physical downlink shared channel (PDSCH) and UL transmissions on physical uplink shared channel (PUSCH), where the Downlink Control Information (DCI) on PDCCH includes: Downlink assignments containing at least modulation and coding format, resource allocation, and hybrid-automatic repeat request (HARQ) information related to DL-SCH; Uplink scheduling grants containing at least modulation and coding format, resource allocation, and HARQ information related to UL-SCH. In addition to scheduling, PDCCH can be used to for: Activation and deactivation of configured PUSCH transmission with configured grant; Activation and deactivation of PDSCH semi-persistent transmission; Notifying one or more UEs of the slot format; Notifying one or more UEs of the physical resource block(s) (PRB(s)) and orthogonal frequency-division multiplexing (OFDM) symbol(s) where the UE may assume no transmission is intended for the UE; Transmission of transmit power control (TPC) commands for physical uplink control channel (PUCCH) and PUSCH; Transmission of one or more TPC commands for SRS transmissions by one or more UEs; Switching a UE's active bandwidth part; Initiating a random access procedure.

A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own demodulation reference signal (DMRS). Quadrature phase shift keying (QPSK) modulation is used for PDCCH.

In fifth generation wireless communication system, a list of search space configurations are signaled by gNB for each configured BWP wherein each search configuration is uniquely identified by an identifier. Identifier of search space configuration to be used for specific purpose such as paging reception, SI reception, random access response reception is explicitly signaled by gNB. In NR search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’satisfies the equation below:

(y*(number of slots in a radio frame)+x−Monitoring-offset-PDCCH-slot) mod (Monitoring-periodicity-PDCCH-slot)=0;

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. Search space configuration includes the identifier of coreset configuration associated with it. A list of coreset configurations are signaled by gNB for each configured BWP wherein each coreset configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported SCS is pre-defined in NR.

Each coreset configuration is associated with a list of Transmission configuration indicator (TCI) states. One DL RS ID (SSB or CSI RS) is configured per TCI state. The list of TCI states corresponding to a coreset configuration is signaled by gNB via radio resource control (RRC) signaling. One of the TCI state in TCI state list is activated and indicated to UE by gNB via a medium access control (MAC) control element (CE). TCI state indicates the DL TX beam (DL TX beam is QCLed with SSB/CSI RS of TCI state) used by gNB for transmission of PDCCH in the PDCCH monitoring occasions of a search space. For PDSCH, TCI state of scheduling PDCCH can be used for scheduled PDSCH. Alternately, TCI state of the PDCCH for the lowest corset ID in the slot is used for PDSCH. Alternately combination of RRC+MAC CE+DCI is used to indicate the TCI state for PDSCH. RRC configures a list of TCI state, MAC CE indicates a subset of these TCI states and DCI indicates one of the TCI state from list of TCI states indicated in MAC CE.

In fifth generation wireless communication system bandwidth adaptation (BA) is supported. With BA, the receive and transmit bandwidth of a UE need not be as large as the bandwidth of the cell and can be adjusted: the width can be ordered to change (e.g. to shrink during period of low activity to save power); the location can move in the frequency domain (e.g. to increase scheduling flexibility); and the subcarrier spacing can be ordered to change (e.g. to allow different services). A subset of the total cell bandwidth of a cell is referred to as a Bandwidth Part (BWP). BA is achieved by configuring RRC connected UE with BWP(s) and telling the UE which of the configured BWPs is currently the active one.

When BA is configured, the UE only has to monitor PDCCH on the one active BWP i.e. it does not have to monitor PDCCH on the entire DL frequency of the serving cell. In RRC connected state, UE is configured with one or more DL and UL BWPs, for each configured Serving Cell (i.e. PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the media access control (MAC) entity itself upon initiation of Random Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

In the 5G system's architectural framework, a notable development is the split options of the gNB's internal structure into two components: a Central Unit (CU) and a Distributed Unit (DU). These components are interconnected through an F1 interface. While the partitioning can theoretically occur at any layer within the protocol stack, splitting between RLC and PDCP layers may be preferred. This option may allow traffic aggregation from NR and E-UTRA transmission points to be centralized and facilitate the management of traffic load between NR and E-UTRA transmission points.

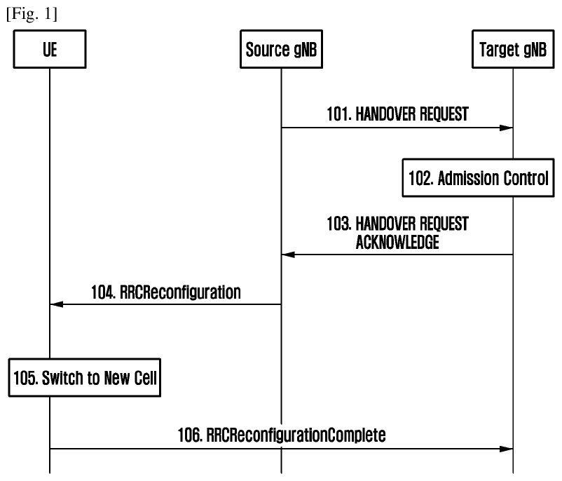

FIG. 1 illustrates a signaling procedures for an inter-gNB handover according to an embodiment of the disclosure.

In in fifth generation wireless communication system, there are two types of mobility: cell level mobility and beam level mobility. The cell level mobility may require an explicit RRC signaling to be triggered, i.e. handover command.

Referring to FIG. 1, in operation 101, a source gNB may initiate a handover and issue a HANDOVER REQUEST over the Xn interface. In operation 102, a target gNB may perform an admission control. In operation 103, the target gNB may provide a new RRC configuration as part of a HANDOVER REQUEST ACKNOWLEDGE. In operation 104, the source gNB may provide the RRC configuration to a UE by forwarding an RRCReconfiguration message received in the HANDOVER REQUEST ACKNOWLEDGE. The RRCReconfiguration message may include at least cell identifier (ID) and information required to access the target cell (target gNB) so that the UE can access the target cell without reading system information. For some cases, the information required for a contention-based and/or a contention-free random access can be included in the RRCReconfiguration message. The access information to the target cell may include beam specific information, if any. In operation 105, the UE may switch to the new cell (i.e., target cell). moving the RRC connection to the target gNB. In operation 106, the UE may reply to the target gNB with an RRCReconfigura-tionComplete message. Several types of handover, normal handover, conditional handover and DAPS handover can be supported in the disclosure.

Beam Level Mobility may not require explicit RRC signalling to be triggered. The gNB may provide the UE with a measurement configuration for serving cell via RRC signalling. The measurement configuration may contain configurations of synchronization signal block (SSB)/channel state information reference signal (CSI-RS) resources and resource sets, reports and trigger states for triggering channel and interference measurements and reports. Beam Level Mobility can be handled at lower layers by physical (PHY) layer and/or MAC layer control signalling, and the RRC layer may not be required to know which beam is being used at a given point in time. Based on the physical layer and/or MAC layer control signalling, the UE can be switched from one beam to another in the serving cell.

Lower Layer Mobility is a new type of lower layer mobility also referred as L1/L2-triggered mobility or lower layer triggered mobility (LTM) being investigated. The Lower Layer Mobility may be based on L1 measurements that are provided by the UE to the serving cell. Based on these measurements, handover may be triggered by sending an L1 (e.g. DCI) or L2 (e.g. MAC CE) command. In Lower Layer Mobility, the serving cell change may be triggered based on L1 beam measurements instead of L3 cell power and quality measurements that are configured in NR baseline handover of Release 15. L3 cell quality measurements may be reported only after a certain Time-to-Trigger (TTT) has expired for a measurement event. L3 measurements may also be filtered based on an L3 configuration over multiple measurements before reporting. L1 measurements may have the benefit that the network can react more quickly to radio link degradation on the serving link as the network can save the delay caused by L3 filtering and TTT for the handover decision. This should result in reducing in the number of radio link failures compared to baseline handover.

In the legacy handover, the RRC procedure delay consists of RRC signal processing related to decoding of the handover command and L2/3 reconfiguration of the protocol layers. For lower layer mobility, the RRC procedure delay can be reduced as the UE can receive and decode the configuration of the target cells before the cell change occurs. Furthermore, since lower layer mobility is restricted to the intra-CU scenario with the same PDCP and RRC layers, L2/3 reconfigurations can be minimized by keeping the same configuration for PDCP and RRC layers and possibly other layers, such as RLC and MAC layers, in the intra-DU scenario. For example, in the inter-DU scenario the new target cell may have different configurations for RLC and MAC layers. In the best case for intra-DU, the target cell can reconfigure only the new cell-radio network temporary identifier (C-RNTI) which can save the entire L2/3 reconfiguration for the UE.

In legacy handover there can be delays due to the RF/baseband retuning, derivation of target gNB security keys and the configuration of the security algorithm to be used in the target cell. These can also be avoided in lower layer mobility. As the PDCP entity in the CU is the same for both source and target cells, the same security keys and algorithms can be applied which reduces the interruption time.

In the legacy handover there can be an interruption due to the uncertainty of acquiring the first available physical random access channel (PRACH) occasion in the new cell. In addition, there can be interruptions of sending the PRACH preamble and receiving the RACH response (RAR). These random access related interruption components can be reduced in Lower Layer Mobility by introducing RACH-less handover, where the UE can skip the entire random-access procedure to the target cell. For scenarios where the RACH-less handover cannot be applied, the UE may acquire the timing advance of the prepared target cells before the actual handover occurs.

In wireless communication systems, contention-free random access (CFRA) can be supported for L1/L2 based mobility. Such CFRA resources for L1/L2 mobility may be signaled using RRCReconfiguration or via L1/L2 cell change commands for each respective candidate target cell. However, once the random access procedure for L1/L2 based mobility has been completed, the subsequent behavior of the UE remains undefined. Specifically, it is unclear whether the UE should release resources or maintain the configuration.

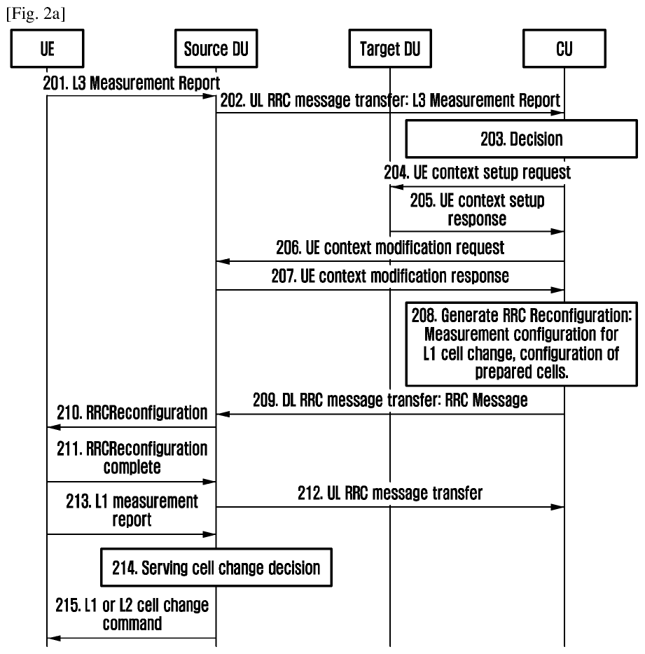

FIGS. 2a and 2b illustrate a first method in a lower layer based mobility procedure according to an embodiment of the disclosure.

A UE may send measurement report(s) containing the measurements of serving and target cell(s) in operations 201 and 202. The measurement report may be sent to the serving cell. A serving DU (i.e., source DU) of the serving cell then may forward the report(s) to a CU.

Based on the reported measurements, the CU may identify a potential set of candidate target cells to which the UE can be handed over to, in operation 203. In this example, the CU may identify one or more candidate target cells where the candidate target cell is served by either the source DU or another DU (i.e., target DU) which are controlled by the same CU.

The CU may request the preparation of a candidate target cell controlled by the target DU by sending UE Context Setup Request message, in operation 204. The target DU may provide the configuration of the UE in UE Context Setup Response messages, respectively in operation 205. Each message may include a container from DU to CU. The configuration may contain UE-specific and non-UE-specific parts. In an embodiment, operation 204 and operation 205 may not be performed if candidate target cells of the other DU are not identified in operation 203.

The CU may request the preparation of a candidate target cell controlled by the source DU by sending UE Context Modification Request message in operation 206. The source DU may provide the configuration of the UE in UE Context Modification Response message including a container from DU to CU in operation 207. The configuration may contain UE-specific and non-UE-specific parts. In an embodiment, operation 206 and operation 207 may not be performed if candidate target cells of the source DU are not identified in operation 203.

Upon receiving the UE configurations for the candidate target cell(s), the CU may generate an RRC Reconfiguration (in operation 208) to be sent to the UE in operations 209 and 210. The CU may send the configuration to the source DU which then sends the configuration to the UE. Among other information, the RRC Re-configuration message may contain at least one of: CFRA resources for L1/L2 mobility; Measurement reporting configuration for L1/L2 mobility (i.e., configuration on how to report the L1 beam measurements of serving and target cells); Configuration of the prepared candidate cell(s) which the UE needs to execute when the UE receives a L1/L2 command to change the serving cell, such as random access configuration; radio bearer configurations; indication of whether to perform a PDCP re-establishment or not (per DRB or common for all); indication of whether to perform a PDCP level data recovery or not (per DRB or common for all); indication of whether to perform an RLC re-establishment or not (per DRB or RLC channel or common for all); indication of whether to perform a MAC reset or partial MAC reset or not, etc.

The RRC Reconfiguration may also include firstActiveUplinkBWP and firstActive-DownlinkBWP for each prepared candidate cell(s) and a list of DL and UL BWP configurations for each prepared candidate cell(s). The RRC Reconfiguration may also include InitialUplinkBWP and InitialDownlinkBWP for each prepared candidate cell(s) and a list of DL and UL BWP configurations for each prepared candidate cell(s).

The UE may confirm the RRC Reconfiguration to the network in operations 211 and 212.

After confirming the RRC Reconfiguration to the network, the UE may start to report the L1 beam measurement of the serving cell and candidate target cells in operation 213. Based on the measurements, the serving cell may decide to trigger a cell change command in operation 214. In an example, upon determining that there is a target candidate cell having a better radio link/beam measurement than the serving cell (operation 214), e.g., L1-RSRP of target beam measurement>L1-RSRP of serving beam measurement+Offset for a time period (i.e. Time-to-Trigger (TTT) period), the serving cell may send an L1 (DCI) or L2 (MAC CE) cell change/switch command in operation 215 to trigger the cell change to the target candidate cell. The cell switch/change command (MAC CE or DCI) may include a TCI state for monitoring a PDCCH in target cell. The TCI state may be determined by the serving cell/DU or serving CU in operation 214. Alternately, the TCI state may be decided by the target cell/DU and informed to the serving cell/DU. The cell switch/change command (MAC CE or DCI) may include Contention free random access resources for 2 step and/or 4 step RA.

In operation 216, the UE may initiate a random access (RA) procedure towards the target cell indicated in the L1 or L2 cell change/switch command.

Upon completion of the RA procedure, in operation 217, the UE may maintain or may not release the CFRA resources configured in the RRCReconfiguration in operation 210 or in the cell switch/change command (MAC CE or DCI) in operation 215. In an embodiment, the configuration for the CFRA received in operation 210 or operation 215 may be kept (maintained) in the UE and the MAC entity of the UE may stop using the resources.

Additionally or alternatively, during the ongoing RA procedure, if the number of message A (MsgA) transmissions is equal to the maximum number of allowed MsgA transmissions and the RA procedure is not yet completed: in operation 218, the UE may maintain or may not release the CFRA resources configured in the RRCReconfiguration in operation 210 or in the cell switch/change command (MAC CE or DCI) in operation 215. In an embodiment, the configuration for the CFRA received in operation 210 or operation 215 may be kept (maintained) in the UE and the MAC entity of the UE may stop using the resources for the ongoing RA procedure.

Upon cell change being successful, in operation 219, the UE may keep the CFRA configuration(s) for other candidate target cells that are received in the RRCReconfiguration in operation 210. The UE can use the CFRA configuration(s) for subsequent cell change/switch commands. In an alternate embodiment, upon cell change being successful, the CFRA configuration(s) for other candidate target cells that are received in the RRCReconfiguration in operation 210 may be released.

More specifically, operations 216 through 219 are described in detail below.
(Condition 1) In an embodiment, if a timing advance (TA) was maintained by the UE for the target cell before the L1/L2 cell switch change/command is received and a time alignment timer (TAT) for a timing advance group (TAG) of the target cell is not running; or
(Condition 2) In an embodiment, if the RRCReconfiguration message received in operation 210 or L1/L2 cell switch/change command received in operation 215 includes an indication to perform a random access (RA) towards the target cell; or
(Condition 3): In an embodiment, if the L 1/L2 cell switch/change command received in operation 215 does not include a TA of the target cell and the UE does not have a valid TA (e.g. TA received from the network before the L1/L2 cell switch/change command or estimated by UE) of the target cell:
* The may UE perform the RA procedure towards the target cell. The UE may use the contention free resources for RA (i.e., CFRA resources), if configured as explained earlier.
* Contention free random access resources for 2 step and/or 4 step RA may be signaled for target cell(s) in operation 210 and/or operation 215. The contention free random access resources includes preamble(s) and/or RO(s) in case of 4 step RA. Contention free random access resources may include preamble(s) and/or RO(s) and/or PUSCH occasion(s) in case of 2 step RA.

In an embodiment, if the RA procedure is initiated upon the L1/L2 cell switch change/command:
* Upon completion of random access procedure, the UE may maintain or may not release the CFRA resources. In an embodiment, the configuration for the CFRA received in operation 210 and/or operation 215 may be kept (maintained) in the UE and the MAC entity of the UE may stop using the resources (i.e., the CFRA resources are released in MAC). The contention free random access resources may include preamble(s) and/or RO(s) in case of 4 step RA. Alternatively, the contention free random access resources may include preamble(s) and/or RO(s) and/or PUSCH occasion(s) in case of 2 step RA.

* During the ongoing RA procedure, if the number of MsgA transmissions is equal to the maximum number of allowed MsgA transmissions and the RA procedure is not yet completed: the UE may maintain or may not release the CFRA resources. In an embodiment, the RRC configuration for the CFRA may be kept (maintained) in the UE and the MAC entity of the UE may stop using the resources (i.e., the CFRA resources are released in MAC) for the ongoing RA procedure. In an embodiment, the maximum number of allowed MsgA transmissions may be configured by the gNB (or gNB-CU) in the RA configuration. In an embodiment, the UE may check if the number of MsgA transmissions is equal to the maximum number of allowed MsgA transmissions when a message B (MsgB) response window expires or when a contention resolution timer expires during the RA procedure. The contention free random access resources may include preamble(s) and/or RO(s) in case of 4 step RA. Alternatively, the contention free random access resources may include preamble(s) and/or RO(s) and/or PUSCH occasion(s) in case of 2 step RA.

Upon cell change being successful, the CFRA configuration(s) for other candidate target cells that are received in operation 210 may be kept (maintained) and can be used later for subsequent cell change/switch commands. In an alternate embodiment, upon cell change being successful, the CFRA configuration(s) for other candidate target cells that are received in operation 210 may be released.

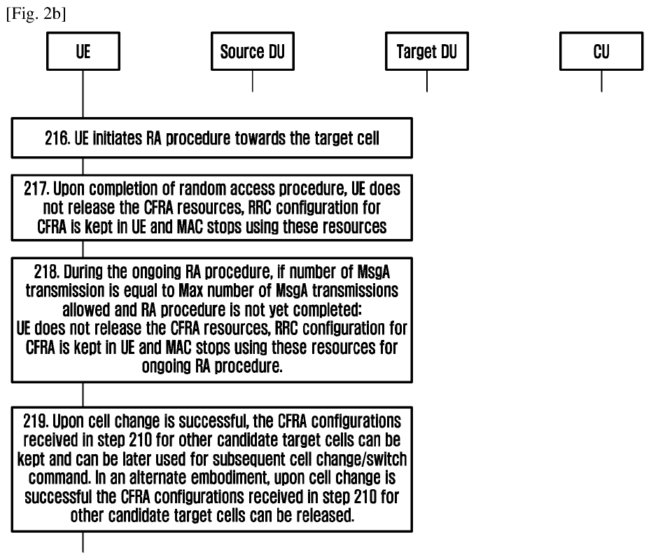

FIGS. 3a and 3b illustrate a second method in a lower layer based mobility procedure according to an embodiment of the disclosure.

A UE may send measurement report(s) containing the measurements of serving and target cell(s) in operations 301 and 302. The measurement report may be sent to the serving cell. A serving DU (i.e., source DU) of the serving cell then may forward the report(s) to a CU.

Based on the reported measurements, the CU may identify a potential set of candidate target cells to which the UE can be handed over to, in operation 303. In this example, the CU may identify one or more candidate target cells where the candidate target cell is served by either the source DU or another DU (i.e., target DU) which are controlled by the same CU.

The CU may request the preparation of a candidate target cell controlled by the target DU by sending UE Context Setup Request message, in operation 304. The target DU may provide the configuration of the UE in UE Context Setup Response messages, respectively in operation 305. Each message may include a container from DU to CU. The configuration may contain UE-specific and non-UE-specific parts. In an embodiment, operation 304 and operation 305 may not be performed if candidate target cells of the other DU are not identified in operation 303.

The CU may request the preparation of a candidate target cell controlled by the source DU by sending UE Context Modification Request message in operation 306. The source DU may provide the configuration of the UE in UE Context Modification Response message including a container from DU to CU in operation 307. The configuration may contain UE-specific and non-UE-specific parts. In an embodiment, operation 306 and operation 307 may not be performed if candidate target cells of the source DU are not identified in operation 303.

Upon receiving the UE configurations for the candidate target cell(s), the CU may generate an RRC Reconfiguration (in operation 308) to be sent to the UE in operations 309 and 310. The CU may send the configuration to the source DU which then sends the configuration to the UE. Among other information, the RRC Re-configuration message may contain at least one of: CFRA resources for L1/L2 mobility; Measurement reporting configuration for L1/L2 mobility (i.e., configuration on how to report the L1 beam measurements of serving and target cells); Configuration of the prepared candidate cell(s) which the UE needs to execute when the UE receives a L1/L2 command to change the serving cell, such as random access configuration; radio bearer configurations; indication of whether to perform a PDCP re-establishment or not (per DRB or common for all); indication of whether to perform a PDCP level data recovery or not (per DRB or common for all); indication of whether to perform an RLC re-establishment or not (per DRB or RLC channel or common for all); indication of whether to perform a MAC reset or partial MAC reset or not, etc. The RRC Reconfiguration may also include firstActiveUplinkBWP and firstActive-DownlinkBWP for each prepared candidate cell(s) and a list of DL and UL BWP configurations for each prepared candidate cell(s). The RRC Reconfiguration may also include InitialUplinkBWP and InitialDownlinkBWP for each prepared candidate cell(s) and a list of DL and UL BWP configurations for each prepared candidate cell(s).

The UE may confirm the RRC Reconfiguration to the network in operations 311 and 312.

After confirming the RRC Reconfiguration to the network, the UE may start to report the L1 beam measurement of the serving cell and candidate target cells in operation 313. Based on the measurements, the serving cell may decide to trigger a cell change command in operation 314. In an example, upon determining that there is a target candidate cell having a better radio link/beam measurement than the serving cell (operation 314), e.g., L1-RSRP of target beam measurement>L1-RSRP of serving beam measurement+Offset for a time period (i.e. Time-to-Trigger (TTT) period), the serving cell may send an L1 (DCI) or L2 (MAC CE) cell change/switch command in operation 315 to trigger the cell change to the target candidate cell. The cell switch/change command (MAC CE or DCI) may include a TCI state for monitoring a PDCCH in target cell. The TCI state may be determined by the serving cell/DU or serving CU in operation 314. Alternately, the TCI state may be decided by the target cell/DU and informed to the serving cell/DU. The cell switch/change command (MAC CE or DCI) may include Contention free random access resources for 2 step and/or 4 step RA.

In operation 316, the UE may initiate a random access (RA) procedure towards the target cell indicated in the L1 or L2 cell change/switch command.

Upon completion of the RA procedure; or during the ongoing RA procedure, if the number of message A (MsgA) transmissions is equal to the maximum number of allowed MsgA transmissions and the RA procedure is not yet completed: if the network indicates the UE to release the resources, in operation 317, the UE may release the CFRA resource configuration and the MAC entity of the UE may stop using the resources. Otherwise (i.e., if the network does not indicate the UE to release the resources), in operation 317, the UE may maintain or may not release the CFRA resources, the configuration for the CFRA received in operation 310 or operation 315 may be kept (maintained) in the UE and the MAC entity of the UE may stop using the resources for the ongoing RA procedure.

If the network indicates the UE to release the resources, upon cell change being successful, in operation 318, the UE may release the CFRA configuration(s) for other candidate target cells that are received in the RRCReconfiguration in operation 310. Otherwise (i.e., if the network does not indicate the UE to release the resources), upon cell change being successful, the CFRA configuration(s) for other candidate target cells that are received in the RRCReconfiguration in operation 310 may be kept (maintained) and can be used later for subsequent cell change/switch commands.

More specifically, operations 316 through 318 are described in detail below.
(Condition 1) In an embodiment, if a timing advance (TA) was maintained by the UE for the target cell before the L1/L2 cell switch change/command is received and a time alignment timer (TAT) for a timing advance group (TAG) of the target cell is not running; or
(Condition 2) In an embodiment, if the RRCReconfiguration message received in operation 310 or L1/L2 cell switch/change command received in operation 315 includes an indication to perform a random access (RA) towards the target cell; or (Condition 3): In an embodiment, if the L 1/L2 cell switch/change command received in operation 315 does not include a TA of the target cell and the UE does not have a valid TA (e.g. TA received from the network before the L1/L2 cell switch/change command or estimated by UE) of the target cell:
* The may UE perform the RA procedure towards the target cell. The UE may use the contention free resources for RA (i.e., CFRA resources), if configured as explained earlier.
* Contention free random access resources for 2 step and/or 4 step RA may be signaled for target cell(s) in operation 310 and/or operation 315. The contention free random access resources includes preamble(s) and/or RO(s) in case of 4 step RA. Contention free random access resources may include preamble(s) and/or RO(s) and/or PUSCH occasion(s) in case of 2 step RA.

In an embodiment, if the RA procedure is initiated upon the L1/L2 cell switch change/command:
* Upon completion of random access procedure; or during the ongoing RA procedure, if the number of MsgA transmissions is equal to the maximum number of allowed MsgA transmissions and the RA procedure is not yet completed:
** If the network indicates the UE to release the resources,
*** The UE may release the CFRA resource configuration. The MAC entity of the UE may stop using the resources.
** Else,
** The UE may maintain or may not release the CFRA resources, The RRC configuration for the CFRA received in operation 310 and/or operation 315 may be kept (maintained) in the UE and the MAC entity of the UE may stop using the resources (i.e., the CFRA resources are released in MAC). The contention free random access resources may include preamble(s) and/or RO(s) in case of 4 step RA. Alternatively, the contention free random access resources may include preamble(s) and/or RO(s) and/or PUSCH occasion(s) in case of 2 step RA.
* The network's indication to release the resources may be signaled through at least one of: the RRCReconfiguration message (in operation 310) and the L1/L2 cell change/switch command (in operation 315).

In an embodiment, upon cell change being successful:
If the network indicates the UE to release the resources,
** The CFRA configurations(s) for other candidate target cells that are received in operation 310 may be released.
* Else,
** The CFRA configuration(s) for other candidate target cells that are received in operation 310 may be kept (maintained) and can be used later for subsequent cell change/switch commands.
* The network's indication to release the resources may be signaled through at least one of: the RRCReconfiguration message (in operation 310) and the L1/L2 cell change/switch command (in operation 315).

Alternatively, the following procedure may be applied to operations 316 to 318.

In an embodiment, if RA procedure is initiated upon L1/L2 cell switch change/command:
* Upon completion of random access procedure; or during the ongoing RA procedure, if the number of MsgA transmissions is equal to the maximum number of allowed MsgA transmissions and the RA procedure is not yet completed:
** If timer X is not running,
*** The UE may release the CFRA resource configuration. The MAC entity of the UE may stop using the resources.
** Else,
*** The UE may maintain or may not release the CFRA resources, The RRC configuration for the CFRA may be kept (maintained) in the UE and the MAC entity of the UE may stop using the resources (i.e., the CFRA resources are released in MAC). The contention free random access resources may include preamble(s) and/or RO(s) in case of 4 step RA. Alternatively, the contention free random access resources may include preamble(s) and/or RO(s) and/or PUSCH occasions(s) in case of 2 step RA.

The contention free random access resources can be released when timer X expires.
* The network may signals the value of timer X through at least one of: the RRCReconfiguration message (operation 310) and the L1/L2 cell change/switch command (step 15).
* Timer X may start when the contention free random access resource configuration is received. The contention free random access resources may be released when timer X expires. In an embodiment, if the timer X expires during the ongoing RA procedure initiated upon L1/L2 cell switch change/command, the contention free random access resources may be released, after completion of RA procedure, or if the number of MsgA transmissions is equal to the maximum number of allowed MsgA transmissions and the RA procedure is not yet completed.

In an embodiment, upon cell change being successful:
* If timer X is not running,
** The CFRA configurations(s) for other candidate target cells that are received in operation 310 may be released.
* Else,
** The CFRA configuration(s) for other candidate target cells that are received in operation 310 may be kept (maintained) and can be used later for subsequent cell change/switch commands.

Small Data Transmission (SDT) is a procedure allowing data and/or signalling transmission while remaining in RRC_INACTIVE state (i.e., without transitioning to RRC_CONNECTED state). Mobile-originated SDT (MO-SDT) is enabled on a radio bearer basis and is initiated by the UE only if there is less than a configured amount of UL data awaiting to be transmitted across all radio bearers for which SDT is enabled, the DL RSRP is above a configured threshold, and a valid SDT resource is available. Mobile-terminated SDT (MT-SDT) based on DL data arrival in the network for RRC INACTIVE UE may be initiated by network.

While a UE is in RRC_INACTIVE state, the UE context may be kept at the last serving gNB. The last serving gNB may also keep the UE-associated new generation (NG) connection with the serving access and mobility management function (AMF) and user plane function (UPF). In RRC_INACTIVE state, a radio access network (RAN) paging may be triggered if the last serving gNB receives DL data from the UPF or DL UE-associated signalling from the AMF (except the UE Context Release Command message). For RAN paging, the last serving gNB may page in the cells corresponding to a RAN-based notification area (RNA) and may send an Xn application protocol (XnAP) RAN Paging to neighbour gNB(s) if the RNA includes the cells of the neighbor gNB(s).

Since a mobile-terminated SDT (MT-SDT) may be triggered by a gNB upon arrival of DL data/signalling for a UE from a UPF/AMF, it is natural to consider the transmission of MT-SDT indication from the gNB to the UE together with a RAN paging. For RAN paging, the gNB may transmit a PDCCH addressed to a paging radio network temporary identifier (P-RNTI) which schedules a transport block (TB) for a paging message. The paging message may include a paging record for the paged UE's inactive RNTI (I-RNTI). Since the MT-SDT indication is a UE specific indication, the MT-SDT indication may be included in the paging message (e.g., per PagingRecord).

Upon arrival of DL data/signalling from the UPF/AMF, the gNB may need to decide whether to trigger the MT-SDT or not. There are several options to consider for this trigger:
Option 1A: If a UE supports MT-SDT and DL data/signaling arrives from the UPF/AMF, the gNB may trigger the MT-SDT.
Option 1B: If a UE supports MT-SDT and DL data/signaling arrives from the UPF/AMF and the volume of data/signaling is equal to or less than a threshold, the gNB may trigger the MT-SDT.
Option 2A: If a UE supports MT-SDT and DL data/signaling arrives from the UPF/AMF only for SDT (or MT-SDT) radio bearer(s), the gNB may trigger the MT-SDT.
Option 2B: If a UE supports MT-SDT, DL data/signaling arrives from the UPF/AMF only for SDT radio bearer(s), and the volume of the DL data/signaling for SDT (or MT-SDT) radio bearer(s) is equal to or less than a threshold, the gNB may trigger the MT-SDT.

In Option 1A, the gNB may trigger the MT-SDT frequently. Option 1B may not aligned with a mobile-originated SDT (MO-SDT). Option 2A or 2B does not trigger MT_SDT frequently and is aligned with MO-SDT, wherein the data volume of SDT RBs is considered for triggering the SDT procedure. Since the RBs configured for SDT (or MT-SDT) is stored in the UE context, the gNB may use the information to trigger the MT-SDT. For the data volume threshold for MT-SDT, the exact threshold to apply can be left to network implementation.

The RAN paging may be done via cells of gNB(s) other than the last serving gNB in the same RNA. In this case, it needs to be determined whether the last serving gNB or other gNB(s) decide whether to send the MT-SDT indication in the paging message to the UE. Since the last serving gNB has the UE's context and DL data/signaling arrives at this gNB from UPF/AMF, the last serving gNB may determine whether to trigger the MT-SDT or not and may inform the same to the other gNB(s) via an XnAP Paging message. In an alternative option, the last serving gNB may inform the other gNB(s) of the data volume and associated RBs of data in the buffer and UE capability. Upon receiving, from last serving gNB, the MT-SDT indication in XnAP Paging message for a UE, a gNB may send the MT-SDT indication for that UE in a paging message.

Upon receiving the paging message including the I-RNTI of the UE and the MT-SDT indication, the UE may initiate either the configured grant SDT (CG-SDT) or random access SDT (RA-SDT). The selection between CG-SDT and RA-SDT can be done as follows:
Option 1:
* The UE may select a UL carrier (NUL or SUL).
* If CG-SDT resources are configured on the selected UL carrier and a TA is valid (or the TA is valid in the first available CG occasion, or the TA is valid in the first available CG occasion corresponding to an SSB configured for CG-SDT with SS-RSRP above cg-SDT-RSRP-ThresholdSSB) and if at least one SSB configured for CG-SDT with SS-RSRP above cg-SDT-RSRP-ThresholdSSB is available:
** CG-SDT may be selected.
* Else if RA-SDT resources are configured on the selected UL carrier:
** RA-SDT may be selected.
* Else:
** The UE may not perform SDT.
** In an embodiment, this may not occur if it is assumed that a gNB sends the MT-SDT indication only when the cell supports at least one of CG-SDT and RA-SDT.
* The UE may select the SUL or NUL based on the existing method.
Option 2:
* If CG-SDT resources are configured on the selected UL carrier and a TA is valid (or the TA is valid in the first available CG occasion, or the TA is valid in the first available CG occasion corresponding to an SSB configured for CG-SDT with SS-RSRP above cg-SDT-RSRP-ThresholdSSB) and if at least one SSB configured for CG-SDT with SS-RSRP above cg-SDT-RSRP-ThresholdSSB is available and DL RSRP is greater than a threshold:
** CG-SDT may be selected.
* Else if RA-SDT resources are configured on the selected UL carrier and DL RSRP is greater than a threshold:
** RA-SDT may be selected.
* Else:
** The UE may not perform SDT.
* The UE may select the SUL or NUL based on the existing method.

The difference between Option 1 and Option 2 is that Option 2 considers DL RSRP in the procedure for selecting between CG-SDT and RA-SDT, whereas Option 1 does not. Even if the network has indicated MT-SDT indication, it is possible that the UE's DL quality is not good and it would not be efficient to transmit data in downlink in RRC_INACTIVE state.

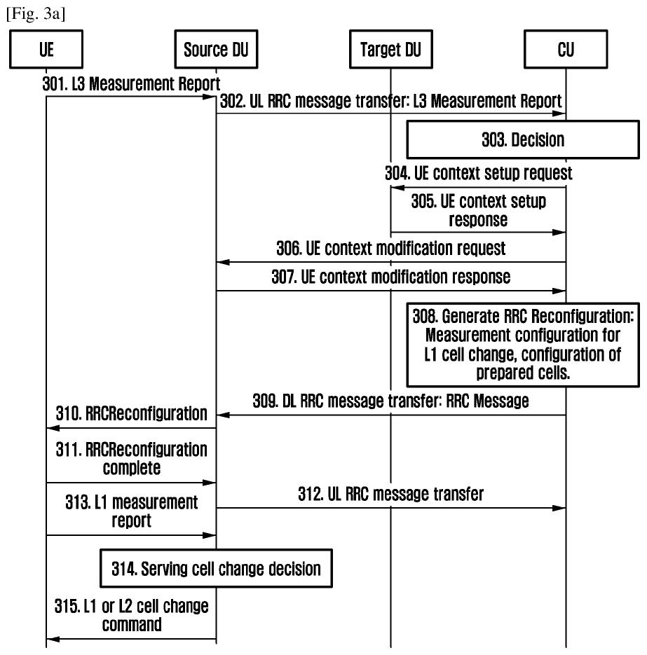

FIG. 4 illustrates a block diagram of a terminal according to an embodiment of the disclosure.

Referring to FIG. 4, a terminal includes a transceiver 410, a controller 420 and a memory 430. The controller 420 may refer to a circuitry, an application-specific integrated circuit (ASIC), or at least one processor. The transceiver 410, the controller 420 and the memory 430 are configured to perform the operations of the UE illustrated in the figures, e.g. FIGS. 1 to 3B, or described above. Although the transceiver 410, the controller 420 and the memory 430 are shown as separate entities, they may be realized as a single entity like a single chip. Or, the transceiver 410, the controller 420 and the memory 430 may be electrically connected to or coupled with each other.

The transceiver 410 may transmit and receive signals to and from other network entities, e.g., a base station.

The controller 420 may control the UE to perform functions according to one of the embodiments described above.

For example, the controller 420 is configured to receive, via the transceiver 410, a configuration message including information on a CFRA resource, receive, via the transceiver 410, an LTM cell change command to switch to a target cell, initiate a random access procedure for the target cell using the CFRA resource, and upon completion of the random access procedure, maintain the CFRA resource.

In an embodiment, the operations of the terminal may be implemented using the memory 430 storing corresponding program codes. Specifically, the terminal may be equipped with the memory 430 to store program codes implementing desired operations. To perform the desired operations, the controller 420 may read and execute the program codes stored in the memory 430 by using a processor or a central processing unit (CPU).

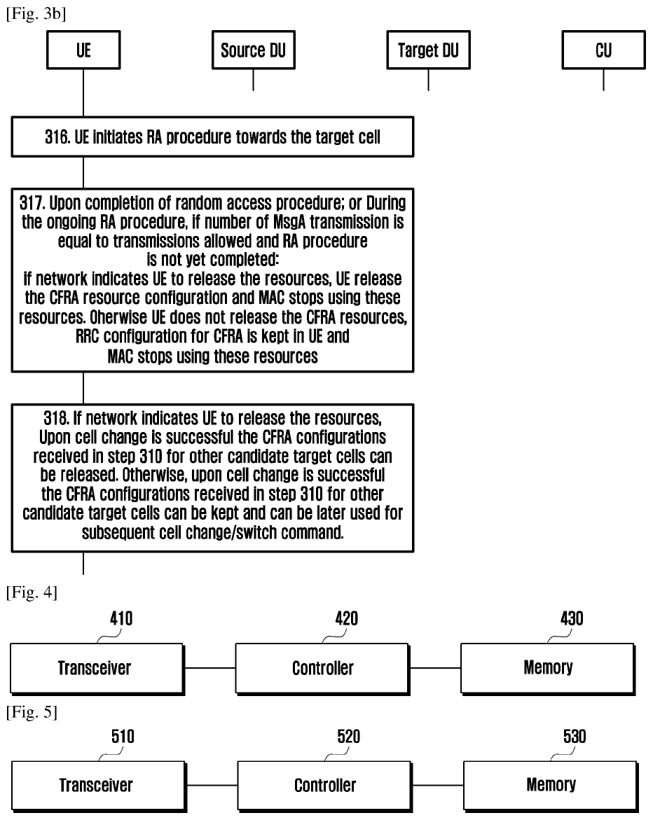

FIG. 5 illustrates a block diagram of a base station according to an embodiment of the disclosure.

Referring to FIG. 5, a base station includes a transceiver 510, a controller 520 and a memory 530. In one embodiment, the base station may be a CU or a DU in the split gNB structure as described above. In one embodiment, the base station may include at least one of a CU, a first DU (i.e., source/serving DU), and a second DU (i.e., target DU) in the split gNB structure as described above. The transceiver 510, the controller 520 and the memory 530 are configured to perform the operations of the network (e.g., gNB) illustrated in the figures, e.g. FIGS. 1 to 3B, or described above. Although the transceiver 510, the controller 520 and the memory 530 are shown as separate entities, they may be realized as a single entity like a single chip. The transceiver 510, the controller 520 and the memory 530 may be electrically connected to or coupled with each other.

The transceiver 510 may transmit and receive signals to and from other network entities, e.g., a terminal.

The controller 520 may control the base station to perform functions according to one of the embodiments described above. The controller 520 may refer to a circuitry, an ASIC, or at least one processor.

For example, the controller 520 is configured to transmit, via the transceiver 510, a configuration message including information on a CFRA resource, transmit, via the transceiver 510, an LTM cell change command to switch to a target cell. The CFRA resource is maintain even after a random access procedure using the CFRA resource is completed.

In an embodiment, the operations of the base station may be implemented using the memory 530 storing corresponding program codes. Specifically, the base station may be equipped with the memory 530 to store program codes implementing desired operations. To perform the desired operations, the controller 520 may read and execute the program codes stored in the memory 530 by using a processor or a CPU.

While the disclosure has been shown and described with reference to various embodiments thereof, it will be understood by those skilled in the art that various changes in form and details may be made therein without departing from the spirit and scope of the disclosure as defined by the appended claims and their equivalents.

As described above, embodiments disclosed in the specification and drawings are merely used to present specific examples to easily explain the contents of the disclosure and to help understanding, but are not intended to limit the scope of the disclosure. Accordingly, the scope of the disclosure should be analyzed to include all changes or modifications derived based on the technical concept of the disclosure in addition to the embodiments disclosed herein.

1. A method performed by a terminal in a wireless communication system, the method comprising:
receiving a configuration message including information on a contention free random access (CFRA) resource;
receiving a lower layer triggered mobility (LTM) cell change command to switch to a target cell;
initiating a random access procedure for the target cell using the CFRA resource; and
upon completion of the random access procedure, maintaining the CFRA resource.

2. The method of claim 1, wherein a radio resource control (RRC) configuration for the CFRA resource is maintained, and the CFRA resource is released in a medium access control (MAC) entity of the terminal.

3. The method of claim 1, further comprising:
during the random access procedure, in case that a number of message A (MsgA) transmissions is equal to a maximum number of allowed MsgA transmissions and the random access procedure is not completed, maintaining the CFRA resource.

4. The method of claim 1, further comprising:
upon a cell change to the target cell being successful, maintaining at least one CFRA configuration for at least one candidate target cell other than the target cell.

5. The method of claim 4, wherein the at least one CFRA configuration is used for a next LTM cell change command.

6. The method of claim 1, wherein the CFRA resource is maintained, in case that the configuration message does not include an indication indicating release of the CFRA resource.

7. The method of claim 1, wherein the configuration message further includes a value of a timer associated with a duration for maintaining the CFRA resource.

8. The method of claim 7, wherein the timer starts upon the configuration message being received, and in case that the timer expires, the CFRA resource is released.

9. A terminal in a wireless communication system, the terminal comprising:
a transceiver; and
a controller configured to:
receive, via the transceiver, a configuration message including information on a contention free random access (CFRA) resource,
receive, via the transceiver, a lower layer triggered mobility (LTM) cell change command to switch to a target cell,
initiate a random access procedure for the target cell using the CFRA resource, and
upon completion of the random access procedure, maintain the CFRA resource.

10. The terminal of claim 9, wherein a radio resource control (RRC) configuration for the CFRA resource is maintained, and the CFRA resource is released in a medium access control (MAC) entity of the terminal.

11. The terminal of claim 9, wherein the controller is further configured to: during the random access procedure, in case that a number of message A (MsgA) transmissions is equal to a maximum number of allowed MsgA transmissions and the random access procedure is not completed, maintain the CFRA resource.

12. The terminal of claim 9, wherein the controller is further configured to: upon a cell change to the target cell being successful, maintain at least one CFRA configuration for at least one candidate target cell other than the target cell.

13. The terminal of claim 12, wherein the at least one CFRA configuration is used for a next LTM cell change command.

14. The terminal of claim 9, wherein the CFRA resource is maintained, in case that the configuration message does not include an indication indicating release of the CFRA resource.

15. The terminal of claim 9, wherein the configuration message further includes a value of a timer associated with a duration for maintaining the CFRA resource, and
wherein the timer starts upon the configuration message being received, and in case that the timer expires, the CFRA resource is released.
